(19) United States
(12) Patent Application Publication
(10) Pub. No.: US 2020/0078863 A1
(43) Pub. Date: Mar. 12, 2020

(54) METAL ADDITIVE MANUFACTURING METHOD

(71) Applicant: TOYOTA JIDOSHA KABUSHIKI KAISHA, Toyota-shi (JP)

(72) Inventor: Yukihiko NAKAGAWA, Nissin-shi (JP)

(73) Assignee: TOYOTA JIDOSHA KABUSHIKI KAISHA, Toyota-shi (JP)

(21) Appl. No.: 16/512,703

(22) Filed: Jul. 16, 2019

(30) Foreign Application Priority Data
Sep. 6, 2018 (JP) 2018-167012

(51) Int. Cl. B22F 3/105; B33Y 10/00; B33Y 50/00

(52) U.S. Cl. CPC B22F 3/1055; B33Y 10/00; B22F 2003/1057; B22F 2003/1058; B33Y 50/00

(57) ABSTRACT

A metal additive manufacturing method includes designing a support part for supporting the shaped object in the shaped object, performing a metal additive manufacturing analysis on the shaped object in a state in which the support part is formed, detecting a part of the shaped object where residual stress becomes greater than a predetermined value based on a result of the metal additive manufacturing analysis, designing a heat path part to be brought into contact with the part where the residual stress becomes greater than the predetermined value, performing the metal additive manufacturing analysis on the shaped object in a state in which the support part and the heat path part are formed, and performing a shaping process so that the designed support part and the designed heat path part are formed.

### CROSS REFERENCE TO RELATED APPLICATIONS

This application is based upon and claims the benefit of priority from Japanese patent application No. 2018-167012, filed on Sep. 6, 2018, the disclosure of which is incorporated herein in its entirety by reference.

### BACKGROUND

The present disclosure relates to a metal additive manufacturing method.

There is a known metal additive manufacturing method for forming an intended shaped object by irradiating a part of metal powder with a laser beam to cause the metal powder to melt and cure, and repeating further lamination of metal powder and irradiating of the metal powder with a laser beam to cause the metal powder to melt and cure. Japanese Unexamined Patent Application Publication No. 2017-179517 discloses a technique of, in a metal additive manufacturing method, analyzing residual stress (tensile stress) generated in a shaped object, and based on a result of this analysis, changing a structure of a support part for supporting the shaped object during a shaping process and changing irradiation energy of a laser beam in order to reduce the residual stress.

### SUMMARY

However, according to the technique disclosed in Japanese Unexamined Patent Application Publication No. 2017-179517, when a shape of the shaped object is complicated, the structure of the support part needs to be very complicated to reduce the residual stress, but it has not been possible from a realistic point of view to provide such a structure.

The present disclosure has been made in view of the above circumstances. An object of the present disclosure is to provide a metal additive manufacturing method capable of reducing residual stress without the structure of the support part being complicated.

An example aspect of the present disclosure is a metal additive manufacturing method for forming an intended shaped object by repeatedly irradiating a part of metal powder with a laser beam to cause the metal powder to melt and cure, and further laminating metal powder to cause the metal powder to melt and cure. The metal additive manufacturing method includes: designing a support part for supporting the shaped object in the shaped object, performing a metal additive manufacturing analysis on the shaped object in a state in which the support part is formed, detecting a part of the shaped object where residual stress becomes greater than a predetermined value based on a result of the metal additive manufacturing analysis, designing a heat path part to be brought into contact with the part where the residual stress becomes greater than the predetermined value, performing the metal additive manufacturing analysis on the shaped object in a state in which the support part and the heat path part are formed, and performing a shaping process so that the designed support part and the designed heat path part are formed.

The heat path part is disposed at the part where the residual stress becomes high when the metal additive manufacturing analysis is performed in a state in which the support part is disposed. By doing so, thermal energy from the laser beam is released from the part where the residual stress is high through the heat path part, so that a temperature distribution at the part where the residual stress is high is reduced, and the residual stress is reduced.

In the designing of the support part, the support part may be designed in such a way that the support part is formed at a part where an angle with a lamination direction of the shaped object becomes greater than or equal to a predetermined angle. By doing so, it is possible to effectively prevent the shaped object from being broken by its own weight and being unable to maintain its shape during the shaping process.

Further, in the designing of the heat path part, the heat path part is designed in such a way that the heat path part is formed at a part where the angle with the lamination direction becomes less than the designed angle.

According to the present disclosure, it is possible to reduce the residual stress without complicating the structure of the support part.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing a schematic configuration of a shaping apparatus used for a metal additive manufacturing method according to an embodiment;

FIG. 2 is a schematic diagram showing an example of a shaped object formed in a shaping process;

FIG. 3 is a schematic diagram showing another example of the shaped object formed in the shaping process;

FIG. 4 is a schematic diagram showing a state in which a heat path part is formed in the shaped object formed during the shaping process;

FIG. 5 is a contour diagram showing a distribution of residual stress when a metal additive manufacturing analysis is performed on a V-shaped member in a state in which the support part is formed;

FIG. 6 is an enlarged view of a region S surrounded by a broken line in FIG. 5;

FIG. 7 is a schematic diagram showing a state in which the support part and a heat path part are disposed in a V-shaped member;

FIG. 8 is a contour diagram showing a distribution of the residual stress when the metal additive manufacturing analysis is performed on the V-shaped member in a state in which the support part and the heat path part are formed;

FIG. 9 is an enlarged view of the region S surrounded by a broken line in FIG. 8; and

FIG. 10 is a flowchart showing a flow of processing of the metal additive manufacturing method according to this embodiment.

### DESCRIPTION OF EMBODIMENTS

Hereinafter, although the present disclosure will be described with reference to an embodiment of the present disclosure, the present disclosure according to claims is not limited to the following embodiment. Moreover, all the components described in the following embodiment are not necessarily indispensable for means to solve problems. For the clarification of the description, the following description and the drawings may be omitted or simplified as appropriate. Throughout the drawings, the same components are denoted by the same reference signs and repeated descriptions will be omitted as appropriate.

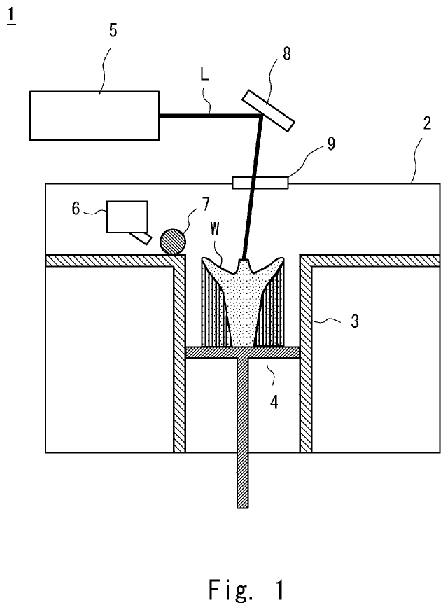

First, a shaping apparatus used for a metal additive manufacturing method according to this embodiment will be described with reference to FIG. 1. FIG. 1: is a schematic diagram showing a schematic structure of the shaping apparatus 1 used for the metal additive manufacturing method according to this embodiment. As shown in FIG. 1, the shaping apparatus 1 includes a chamber 2, a shaping tank 3, a base plate 4, a laser light source 5, a powder supply unit 6, a recoater 7, and a beam scanning mechanism 8.

The base plate 4 is a plate material serving as a base of a shaped object W, and is disposed movably in the vertical direction inside the shaping tank 3. The powder supply unit 6 which supplies metal powder is disposed at an upper part of the shaping tank 3. Here, the metal powder is, for example, an aluminum alloy or a titanium alloy. The recoater 7 is for laying the metal powder supplied from the powder supply unit 6 on the base plate 4 in layers. The shaping tank 3, the base plate 4, the powder supply unit 6, and the recoater 7 are housed inside the chamber 2. An inert gas such as a nitrogen gas or an argon gas may be introduced inside the chamber 2. Further, the inside of the chamber 2 may be evacuated.

The laser light source 5 emits a laser beam L. The beam scanning mechanism 8 scans so that the laser beam L is emitted on a predetermined position of the metal powder. The beam scanning mechanism 8 is, for example, a Galvano mirror. The laser light source 5 and the beam scanning mechanism 8 are provided outside the chamber 2. The laser beam L is made to enter inside the chamber 2 from a light transmitting part 9 provided in the chamber 2.

Next, a metal additive manufacturing process (hereinafter, referred to as a “shaping process”) in the metal additive manufacturing method according to this embodiment will be described. A reference will be made also to FIG. 1 as appropriate in the following descriptions.

In the shaping process, the beam scanning mechanism 8 scans the laser beam L to irradiate a predetermined part of the metal powder with the laser beam L to cause the metal powder to melt and cure. Then, when one layer is formed, metal powder is further laminated by the powder supply unit 6 and the recoater 7, and a predetermined part of the metal powder is melted and cured by irradiation of the laser beam L to thereby form another layer. In this way, by repeating the lamination, melting, and curing of the metal powder, an intended shaped object is formed.

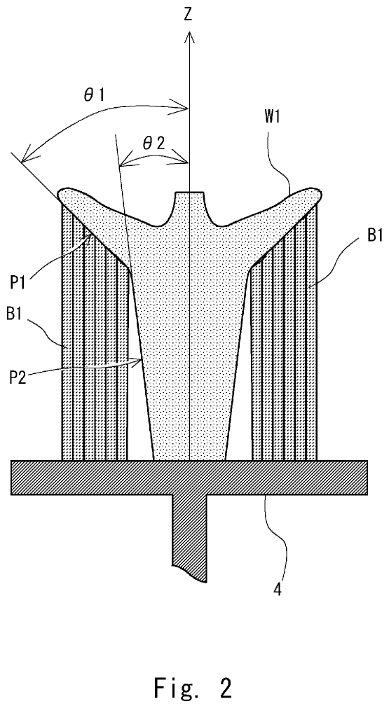

In the shaping process, the support part for supporting the shaped object W is simultaneously formed. Like the shaped object W, the support part is formed by repeating the lamination, melting, and curing of the metal powder. FIG. 2 is a schematic diagram showing an example of a shaped object (shaped object W1) formed in the shaping process. As shown in FIG. 2, a support part B1 is formed at a position where an angle formed with a lamination direction Z of the shaped object W1 is greater than or equal to a predetermined angle. Here, the predetermined angle is α (e.g., 45°). When the angle θ1 formed with the lamination direction Z is greater than or equal to the predetermined angle α (θ1≥α) at a part P1 of the shaped object W1, the support part B1 is provided at the part P1. On the other hand, when the angle θ2 formed with the lamination direction Z is less than the predetermined angle α (θ2<α) at a part P2 of the shaped object W1, the support part B1 is not provided at the part P2. By doing so, it is possible to effectively prevent the shaped object W1 from being broken by its own weight and being unable to maintain its shape during the shaping process.

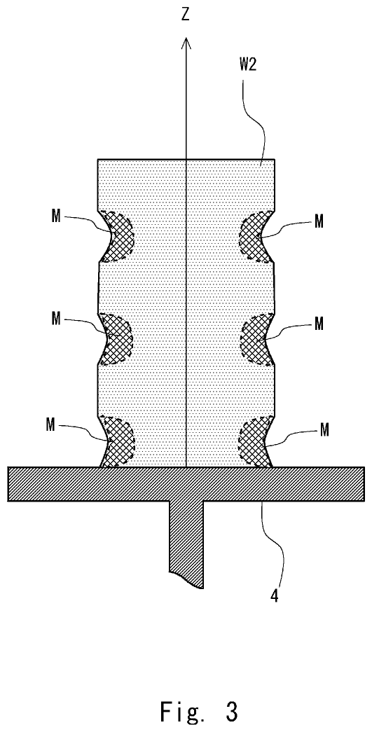

FIG. 3 is a schematic diagram showing another example (a shaped object W2) of the shaped object formed in the shaping process. As shown in FIG. 3, in the shaped object W2, there is no place where the angle formed with the lamination direction Z is greater than or equal to the predetermined angle α. For this reason, in a design process of the support part of the shaped object, it is determined that the support part is unnecessary in the shaped object W2.

However, in the shaped object W2, residual stress is considered to be relatively large at parts M where the thickness varies. Commonly, the part where residual stress tends to increase is a part where the change in the shape is large, like the parts M. This is because the temperature distribution (uneven cooling) is likely to be generated by the irradiation of the laser beam at the part where the change in the shape is large. In the intended shaped object, the part where the residual stress increases can be predicted in advance by performing a metal additive manufacturing analysis. The metal additive manufacturing analysis is for analyzing thermal deformation due to the irradiation of the laser beam in the shaping process. A commercially available analysis tool may be used for the metal additive manufacturing analysis.

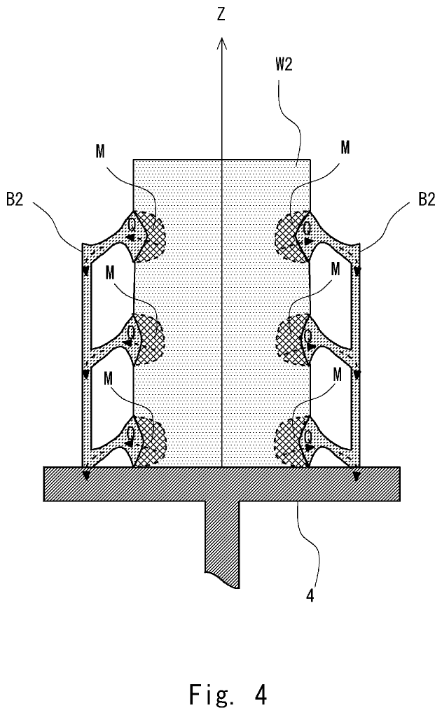

In the metal additive manufacturing method according to this embodiment, in the intended shaped object, a heat path part is formed at a part where the residual stress is expected to be increased by the metal additive manufacturing analysis which has been performed in advance. Like the shaped object W, the heat path part is formed by repeating the lamination, melting, and curing of the metal powder. FIG. 4 is a schematic diagram showing a state in which the heat path part is formed in the shaped object W2 formed in the shaping process. As shown in FIG. 4, a heat path part B2 is brought into contact with the parts M where the residual stress is expected to be increased. By doing so, the thermal energy Q from the laser beam is released from the parts M to the base plate 4 through the heat path part B2, so that the temperature distribution at the place M is reduced, and the residual stress can be reduced.

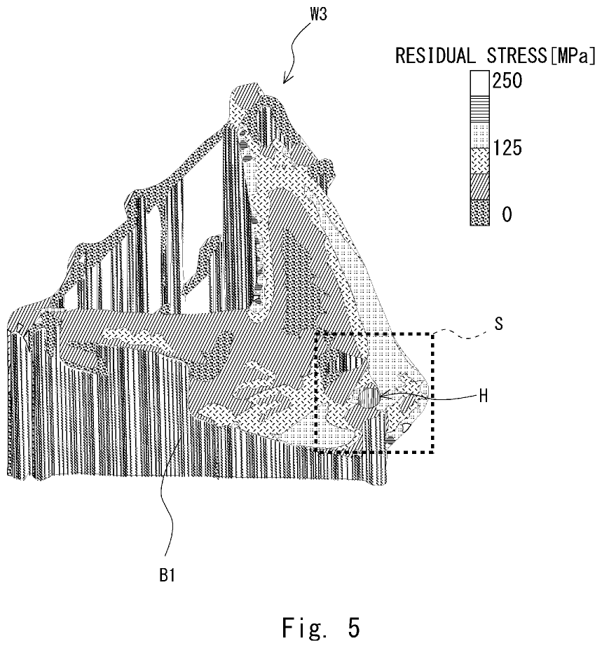

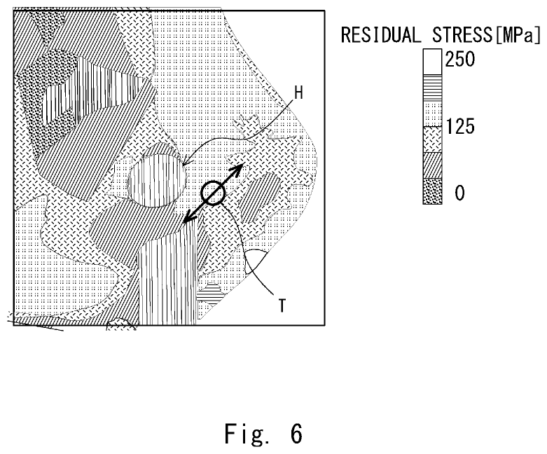

FIG. 5 is a contour diagram showing a distribution of the residual stress when the metal additive manufacturing analysis is performed on a V-shaped member W3 in a state in which the support part B1 is formed. FIG. 6 is an enlarged view of a region S surrounded by a broken line in FIG. 5. Here, the residual stress is maximum principal stress, and the unit thereof is [MPa]. As shown in FIGS. 5 and 6, the residual stress rises to about 180 [MPa] in a region T in the vicinity of a hole H.

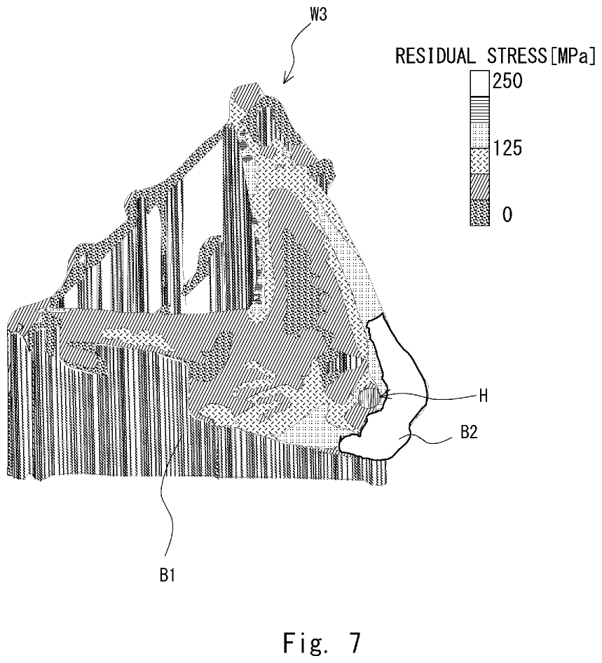

FIG. 7 is a schematic diagram showing a state in which the heat path part B2 is disposed in the V-shaped member W3. As shown in FIG. 7, the heat path part B2 is disposed at a part where the residual stress has become high when the metal additive manufacturing analysis has been performed.

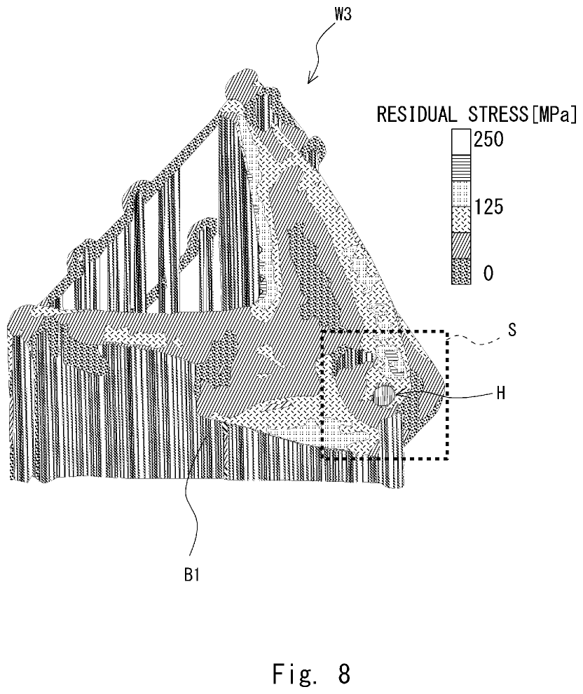

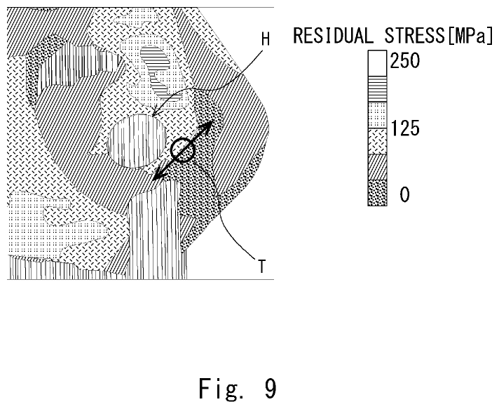

FIG. 8 is a contour diagram showing a distribution of the residual stress when the metal additive manufacturing analysis has been performed on the V-shaped member W3 in a state in which the support part B1 and the heat path part B2 are formed. FIG. 9 is an enlarged view of a region S surrounded by a broken line in FIG. 8. Here, the residual stress is the maximum principal stress, and the unit thereof is [MPa]. Note that the heat path part B2 is not shown in FIGS. 8 and 9. As shown in FIGS. 8 and 9, the residual stress is reduced to about 70 [MPa] in the region T in the vicinity of the hole H. Therefore, it has been confirmed that by disposing the heat path part B2 at the part where the residual stress has become high when the metal additive manufacturing analysis is performed in a state in which the support part B1 is disposed, the residual stress of that part can be effectively reduced.

Next, the process flow of the metal additive manufacturing method according to this embodiment will be described.

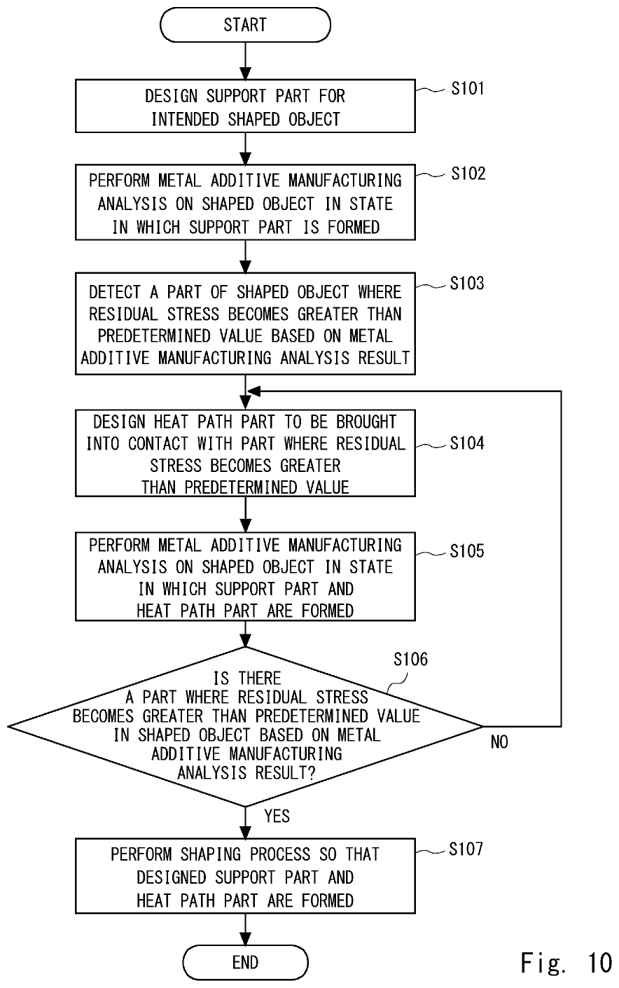

FIG. 10 is a flowchart showing a process flow of the metal additive manufacturing method according to this embodiment. As shown in FIG. 10, firstly, the support part is designed for the intended shaped object (Step S101). Note that the support part may be designed in such a way that the support part is formed at a part where the angle with the lamination direction is greater than or equal to the predetermined angle. By doing so, it is possible to effectively prevent the shaped object from being broken by its own weight and being unable to maintain its shape during the shaping process. Next, the metal additive manufacturing analysis is performed on the shaped object in a state in which the support part is formed (Step S102).

Subsequent to Step 5102, a part of the shaped object where the residual stress becomes greater than the predetermined value is detected based on a result of the metal additive manufacturing analysis (Step S103). Next, the heat path part to be brought into contact with the part where the residual stress becomes greater than the predetermined value is designed (Step S104). Note that the heat path part may be designed in such a way that the heat path part is formed at the position of the shaped object where the residual stress is greater than the predetermined value based on the result of the metal additive manufacturing analysis and also where the angle with the lamination direction becomes less than the predetermined angle. By doing so, it is possible to effectively prevent the heat path part from being formed so as to overlap with the support part. Next, the metal additive manufacturing analysis is performed on the shaped object in a state in which the support part and the heat path part are formed (Step S105).

Subsequent to Step S105, it is determined whether there is a part where the residual stress becomes greater than the predetermined value in the shaped object based on the result of the metal additive manufacturing analysis (Step S106). When it is determined in Step S106 that there is a part in the shaped object where the residual stress becomes greater than the predetermined value, the process returns to Step S104. When it is determined in Step S106 that there is no part in the shaped object where the residual stress becomes greater than the predetermined value, the shaping process is performed such that the designed support part and heat path part are formed (Step S107). Note that the process of Step S107 may be performed following the process of Step S105 without performing the loop condition determination in Step S106.

As described above, in the metal additive manufacturing method according to this embodiment, the heat path part is disposed at the part where the residual stress becomes high when the metal additive manufacturing analysis is performed in a state in which the support part is disposed. As a result, the thermal energy from the laser beam is released to the base plate 4 from the part where the residual stress is high through the heat path part, so that the temperature distribution at the part where the residual stress is high is reduced, and the residual stress is reduced.

The present disclosure is not limited to the above embodiment, and can be modified as appropriate without departing from the scope of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A metal additive manufacturing method for forming an intended shaped object by irradiating a part of metal powder with a laser beam to cause the metal powder to melt and cure, and repeating further lamination of metal powder and irradiating of the metal powder with a laser beam to cause the metal powder to melt and cure, the metal additive manufacturing method comprising:
designing a support part for supporting the shaped object in the shaped object;
performing a metal additive manufacturing analysis on the shaped object in a state in which the support part is formed;
detecting a part of the shaped object where residual stress becomes greater than a predetermined value based on a result of the metal additive manufacturing analysis;
designing a heat path part to be brought into contact with the part where the residual stress becomes greater than the predetermined value;
performing the metal additive manufacturing analysis on the shaped object in a state in which the support part and the heat path part are formed; and
performing a shaping process so that the designed support part and the designed heat path part are formed.

2. The metal additive manufacturing method according to claim 1, wherein in the designing of the support part, the support part is designed in such a way that the support part is formed at a part where an angle with a lamination direction of the shaped object becomes greater than or equal to a predetermined angle.

3. The metal additive manufacturing method according to claim 2, wherein in the designing of the heat path part, the heat path part is designed in such a way that the heat path part is formed at a part where the angle with the lamination direction becomes less than the designed angle.
